(19) United States
(12) Patent Application Publication
(10) Pub. No.: US 2012/0042118 A1
(43) Pub. Date: Feb. 16, 2012

(54) Method for Flash Memory and Associated Controller

(75) Inventors: Cheng-Wei Chou, Hsinchu Hsien (TW); Chien-Yi Chen, Hsinchu Hsien (TW)

(73) Assignee: MStar Semiconductor, Inc., Hsinchu Hsien (TW)

(21) Appl. No.: 13/112,294

(22) Filed: May 20, 2011

(30) Foreign Application Priority Data
Aug. 13, 2010 (TW) 099127204

(51) Int. Cl. G06F 12/00

(52) U.S. Cl. 711/103; 711/E12.008

(57) ABSTRACT

A method is disclosed for a flash memory including a plurality of data units includes determining whether to refresh data of the data units according to number of time the data units that are being read when the flash memory is read. The present invention provides methods for flash memory devices and a specialized controller to utilize values stored in counters relating to the number of read instances of corresponding blocks of data units for the selective control of refreshing data blocks when associated counter values exceed a threshold value.

### CROSS REFERENCE TO RELATED PATENT APPLICATION

This patent application is based on Taiwan, R.O.C. patent application No. 099127204 filed on Aug. 13, 2010.

### FIELD OF THE INVENTION

The present invention relates to a method for a flash memory and associated controller, and more particularly, to a control method for a flash memory and associated controller capable of reducing accessing disturbance by appropriately refreshing data according to the number of times data units are being read in the flash memory.

### BACKGROUND OF THE INVENTION

A flash memory has become one of most important non-volatile memories in a modern information society. Flash memory is a specific type of EEPROM (electrically erasable programmable read-only memory) that is capable of being erased and programmed in large blocks to function as a non-volatile computer storage chip. Flash memory is routinely used in modern memory cards, USB flash drives, media players, and solid-state drives for general storage and transfer of data between computers and other digital products. There is a need in the art to enhance the efficiency of flash memory by increasing data integrity and accuracy, overcoming potential read interferences of the flash memory, and avoiding data errors and data loss caused by accumulation of read instances during usage.

### SUMMARY OF THE INVENTION

A flash memory records data by storing charges via a floating gate. As integrity of the flash memory increases with advanced fabrication techniques, the floating gate of the flash memory gets smaller and smaller and a capability for storing charges of the floating gate is also undesirably affected. Partial charges of the floating gate are lost when data recorded via charges in the floating gate are read. Therefore, as read instances of the flash memory are increased, reliability and accuracy of the recorded data are accordingly reduced. Such situations in which data storage is undesirably affected due to the accumulation of read instances is often called a “read interference”. Although an error correction code (ECC) may be applied to detect/recover an error data when the data is read, the capability of the ECC for recovering the error data can be extremely limited. Considering cost and calculation complexity of data recovery, a general ECC can only recover 1 to 2 bits of each byte of any given error data. When an error occurs in more than 2 bits of each byte of the error data, the ECC cannot recover the error data to restore or determine an original accurate data. When read instances of the flash memory are continuously accumulated, degrees of the errors can become continuously deteriorated and may evolve beyond the capability of the ECC for recovering the error data. The present invention provides a solution with respect to the read interferences to decrease, reduce, and overcome the read interferences of the flash memory.

One object of the present invention is to provide an enhanced method for increasing efficiency of a flash memory comprising a plurality of data units (e.g., pages) by reducing the number of read interferences. The method comprises counting read instances of the data units to generate a plurality of count values; and determining whether to refresh data of the data units according to the frequency of read instances of the specified data units.

In an embodiment, a plurality of counters for recording count values are configured in the flash memory, and each data unit corresponds to one of the counters. When one data unit is read, a predetermined increment is added to the count value of the counter corresponding to the data unit. According to the count values stored in the counters, the read instances of the data units are counted and recorded.

Since data of the flash memory are read in the unit of pages, and the data are erased and written in the unit of blocks, each block comprises a plurality of pages. For example, a flash memory comprises M blocks each comprising N pages (i.e., N data units), and one counter is allocated to every Y data units (where Y is larger than or equal to 1), i.e., a set of Y data units correspond to the same counter. Therefore, N data units of each block correspond to Z counters, where Z=N/Y, where Z is larger than or equal to 1.

In the foregoing embodiment, since the Y data units share one counter, when one of the Y data units is read, the other (Y−1) data units corresponding to the same counter are simultaneously read. Accordingly, read instances of the Y data units corresponding to the same counter are the same, so that the count value of the counter corresponds the read instances of the Y data units.

In order to overcome the problems with read interferences, when a count value of one certain counter is larger than a threshold value, the data units corresponding to the counter are refreshed, i.e., unused data units (e.g., erased standby data units of the flash memory) replace the to-be-refreshed data units to respectively write data of the to-be-refreshed data units corresponding to the counter into the replacement units. That is, the read instances are recorded and monitored via the counters, and data are refreshed via a re-writing approach before the accumulated read instances of the data units may affect data security. Since data rewritten can re-inject enough charges to the floating gate, the data are protected as well as accuracy and reliability of the data being maintained, such that subsequent reading of the data continues and the read interferences are overcome. After the data units corresponding to the counter are refreshed by the replacement data units, the count value of the counter corresponding to the replacement data units is defined as an initial value.

As mentioned above, according to the present invention, N data units (e.g., pages) of one block correspond to Z counters, where Z is larger than 1. Since data are erased and written in the unit of blocks of the flash memory, the data are also refreshed in the unit of blocks. For Z counters corresponding to one certain block, when a count value of one of the Z counters is larger than a threshold value, all N data units of the block are refreshed. For example, another unused block is determined from the flash memory as a replacement block to write data of the N to-be-refreshed data units into N data units corresponding to the replacement block. After the block is refreshed, count values of Z counters corresponding to the replacement block are simultaneously defined as an initial value.

In an embodiment, when the counters are provided to the data units, the counters are configured in a volatile memory (e.g., static random access memory (SRAM) and/or dynamic random access memory (DRAM)). For example, when X bytes of the volatile memory are allocated for configuring the counters, each counter occupies 2 bytes for recording count values from 0 to 65535, so that X/2 counters are configured using X bytes. Since the M blocks of the flash memory respectively correspond to the Z counters, and there are M*Z counters, M*Z is equal to X/2, i.e., Z is equal to X/(2*M). That is, according to the overall number X of bytes of the volatile memory for configuring the counters and the overall number M of the blocks of the flash memory, the number Z of the counters corresponding to each block can be calculated. Accordingly, an overall number Y of data units (e.g., pages) corresponding to each counter is calculated as Y=N/Z, where N is the overall number of data units of a block.

When the flash memory is stopped being implemented, the count values of the counters are written back to the flash memory to maintain the count values via a non-volatile approach. When the flash memory is implemented again, the count values recorded in the flash memory are read into the counters of the volatile memory to continue to count the read instances of the data units of the flash memory.

Another object of the present invention is to provide a controller applied to a flash memory, and the controller comprises an access module, a counter module, and a determining module to overcome read interferences of the flash memory. The flash memory comprises a plurality of data units, and the access module coupled to the flash memory accesses the flash memory. The counter module counts read instances of the data units (e.g., pages) of the flash memory, and generates a plurality of count values. The determining module selectively refreshes data of the data units according to the count values.

In an embodiment, the counter module coupled to a plurality of counters records the count values. Each of the data units corresponds to one of the counters, and each count value corresponds to read instances of the corresponding data unit. When a certain data unit is read, the counter module adds a predetermined increment of the counter corresponding to the data unit to the count value of the counter.

In an embodiment, the counter module coupled to the plurality of counters records the count values. Each data unit corresponds to one counter, and each count value corresponds to read instances of one corresponding data unit. When a certain data unit is read, the counter module adds a predetermined increment to a count value of a counter corresponding to the data unit to count read instances of the data unit according to the count value of the counter. For example, the flash memory comprises M blocks each comprising N data units (e.g., pages), and every Y data units (where Y is larger than or equal to 1) correspond to the same counter, so that each block corresponds to Z counters.

The access module is coupled to a buffer memory, of which a memory capacity is associated with Y data units corresponding to one specific counter. When the access module reads a certain data unit, other Y−1 data units corresponding to the counter are simultaneously read with respect to the counter corresponding to the read data unit, so as to read data of the Y data units corresponding to the counter into a buffer memory. Accordingly, the read instances of the Y data units corresponding to the same counter are the same, and data of the buffer memory are regarded as being cached.

When a count value of a certain counter is larger than a threshold value, the determining module refreshes Y data units corresponding to the counter via the access module. The determining module determines from the flash memory an unused data units corresponding to each to-be-refreshed data unit as a replacement data unit, and the access module respectively writes data of the data units corresponding to the counter into the replacement data units.

For example, when a count value of one of the Z counters corresponding to a certain block is larger than a threshold value, the data units associated with the counter and all remaining data units corresponding to the other Z−1 counters (i.e., all data units of the block) are to be refreshed. The determining module determines an unused block corresponding to the to-be-refreshed block as a replacement block, and the access module re-writes data of the data units of the to-be-refreshed block into corresponding data units of the replacement block. After the refreshment, the counter module redefines the count values of the Z counters corresponding to the replacement data units as an initial value for the elements of the counter array.

As mentioned above, the counters are configured in a volatile memory. When the controller stops implementing the flash memory, the access module writes the count values of the counters back into the flash memory. When the flash memory is implemented again, the access module loads the count values recorded in the flash memory into the counters configured in the volatile memory.

The advantages and spirit related to the present invention can be further understood via the following detailed description and drawings.

### BRIEF DESCRIPTION OF THE DRAWINGS

FIG. 1 is a flow chart of data refreshment in accordance with an embodiment of the present invention.

FIG. 2 is a flow chart of data refreshment triggered by monitoring read instances in accordance with an embodiment of the present invention.

FIG. 3 is a schematic diagram of an electronic system in accordance with an embodiment of the present invention.

### DETAILED DESCRIPTION OF THE PREFERRED EMBODIMENT

According to the present invention, data of a flash memory are maintained via appropriate data refreshments with respect to usage statuses (e.g., read instances of each data unit) of the flash memory to avoid negative effects of read interferences. The flash memory comprises M blocks, each comprising N data units (such as N pages), and each of the data units stores plural bits of data. In the flash memory, writing and erasure of data are performed solely in the unit of blocks. In fact, it is not allowed to erase or modify only a part of specific data units (such as pages) in a given data block of the flash memory. Thus, it is required that all the data in one block be erased prior to performing another data write-in into this same block. Therefore, embodiments of data refreshing of the present invention are performed in the unit of blocks.

FIG. 1 shows a flow chart 100 of data refreshment of the flash memory in accordance with an embodiment of the present invention. Steps of the flow 100 are described in detail below.

In Step 102, the flow 100 begins to refresh a block B(i).

In Step 104, an unused block B(j) is allocated from the flash memory, and data to be refreshed in block B(i) are replicated and written into the block B(j). Certain blocks in the flash memory may be configured as spare blocks, which are typically excluded from being counted as allocated memory space of the flash memory. In this regard, the spare block B(j) is used to act as a replacement block when the block B(i) is to be refreshed so that data of the block B(i) can be saved during block refreshing.

In an embodiment, Step 104 is described in detail below. First, the unused spare block B(j) is allocated; and then, data of the block B(i) is erased and written into the block B(j). The refreshed block B(i) may now be configured as an unused spare block. When the flow 100 is performed again to refresh another block B(k), the block B(i), which is already refreshed and configured as a spare block, may be selected as the replacement block for the block refreshing this time. Accordingly, in the following Step 104, data of the block B(k) are written into the block B(i). After that, the block B(k) is refreshed and may be configured as a spare block. This method of rotation of space block allocation enables efficient usage of the limited memory in the flash memory.

However, in another embodiment of the present invention, Step 104 may be performed in a way that an unused and erased spare block B(j) is allocated firstly, and then the data of the block B(i) are replicated into the block B(j). After that, the data of the original block B(i) are erased, so that the block B(i) becomes an unused and erased spare block. When the flow 100 proceeds to refresh the block B(k), the data of the block B(k) can be written into the block B(i), which acts as an unused and erased standby block.

The concept applied in Step 104 of the embodiments of the present invention is to write/replicate the data of the block B(i) into an erased replacement block B(j).

In Step 106, data of the block B(i) are replicated to the block B(j), which functionally replaces the original block B(i). When the flash memory is utilized in an electronic system, a host of the electronic system addresses the memory spaces in flash memory according to logical addresses that corresponds to physical addresses according to an address lookup table. The flash memory performs data access according to the physical addresses. For example, the logical addresses partition memory spaces of the flash memory into sectors which store data with plural data bits. Each of the sectors corresponds to each data unit (e.g., pages) of each physical block of the flash memory according to the lookup table. In Step 106, updating is performed to modify the address lookup table to transfer a logic address Add(i) of the block B(i) to the block B(j), so that the block B(j) corresponds to the logical address Add(i) originally allocated to the block B(i), and block B(i) is re-defined as a spare block.

After the flow 100 is performed, for the host, the logical address Add(i) is not changed; however, for the flash memory, data at the logical address Add(i) is refreshed from the original block B(i) and moved to the block B(j). Generally, an electric charge of each floating gate of a common block B(i) is gradually lost after several instances of data reading from the block B(i); as a result, data stored at the corresponding logical address Add(i) is at risk of being lost. With implication of the flow 100 of the embodiment according to the present invention, enough charge is saved in the floating gates of the block B(j) to re-configure the data at the local address Add(i), so that the data at the local address Add(i) can endure for subsequent data reading.

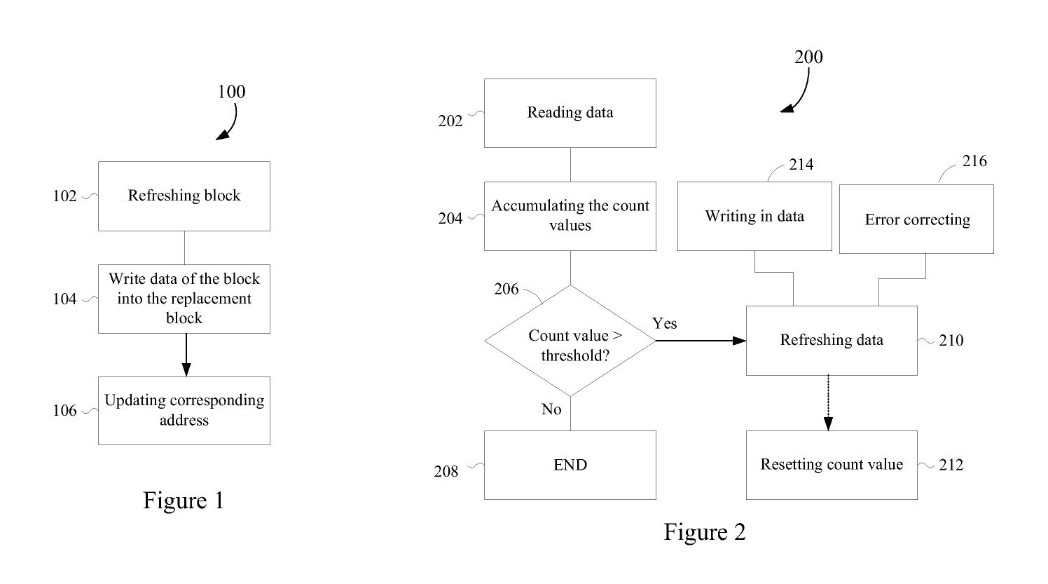

In order to monitor status of the flash memory (e.g., the read instances of the data units) to effectively maintain data in the flash memory, in the data refreshing flow in accordance with the present invention, one counter is allocated for every Y number of data units in the flash memory (where Y is larger than or equal to 1), so the Y number of data units correspond to one same counter. Therefore, assume that N data units of each block correspond to Z number of counters, thus Z is equal to N/Y (Z=N/Y), where Z is greater than or equal to 1. FIG. 2 shows a flow chart of a flow 200 of data refreshment performed according to a number of times of a flash memory being read to achieve protection of data from being lost. The main steps of the flow 200 are described in detail below.

In Step 202, data reading begins. A host sends out a command to access a certain sector (or some set of sectors) of the flash memory. According to the foregoing lookup table, the flash memory reads physical pages corresponding to the sector (or sectors).

In Step 204, when the flash memory reads the physical pages, count values of the counters corresponding to the pages which are being read are accumulated by a predetermined increment, respectively. For example, Y number of data units share an arbitrary counter C(k). When any one data unit (or numerous data units) of the Y number of data units is read, the predetermined increment is added to the count value of the counter C(k), which means that read instances of the Y data units are increased.

In Step 206, it is determined whether the count values of the counters are greater than a threshold value. When the determination result is positive, the flow 200 proceeds to Step 210 in which data are refreshed. Since a block corresponds to a set of Z counters, when a count value of any counter among Z number of counters of a block B(i) is greater than the threshold value, the flow 200 proceeds to Step 210 to refresh data of the block B(i).

When the determination result of whether the count values of the counters are greater than a threshold value is negative, the flow 200 proceeds to Step 208, where the data reading ends. The flow 200 begins again with Step 202 until a next time when the host reads date from the flash memory.

In Step 210, data are refreshed according to the flow 100. For example, when it is determined that data of the block B(i) are to be refreshed in Step 206, data of the data units of the block B(i) are replicated to spare replacement block B(j), and the lookup table is modified accordingly so that the logical address Add(i) of the block B(i) now points to the block B(j), for example, logical addresses of the data units of the block B(i) are changed to correspond to data units of the block B(j), so that the block B(i) is replaced by the block B(j).

In Step 212, when the data of the block B(i) are replicated/written into the block B(j) in Step 210, the Z number of counters corresponding to the replacement block B(j) are reset to an initial value, which means that the data at the logical address Add(i) are capable of enduring being read again, overcoming the read disturbance. The flow 200 again begins with Step 202 until the next time when the host reads the flash memory.

In Step 214, for the flash memory, data writing is equivalent to data refreshment. When the host is to write data into a given sector, the flow 200 proceeds to Step 210, so that the blocks corresponding to that sector are refreshed, and count values of the corresponding counters are reset. For example, when the data of the sector are originally stored in the block B(i), the data of the block B(i) are written into the replacement block B(j) in Step 210, and the count values of the Z number of counters corresponding to the block B(j) are reset in Step 212.

In Step 216, when reading of the data is performed in Step 202, an ECC check is performed on the data which are read. When the ECC check indicates that errors occur in the read data, it also indicates whether it can be recovered. If it indicates that the error can be recovered, correct data can be calculated according to the ECC. Then, the correct data are rewritten into the flash memory.

It is to be noted that, error correcting capabilities of the ECC is rather limited. Without implication of the data refreshing flow according to the present invention, when data loss and errors caused by continuous reading of the flash memory exceed the correcting capability of the ECC, it will result in an unrecoverable data mistake. Compared to the prior art, embodiments in accordance with the present invention can be associated with the ECC check. More specifically, before data errors caused by continuous reading of a block exceed the correcting capability of the ECC, data refreshment brings enough electric charge to re-establish and maintain the data stable in the memory, so that the accumulation of the data errors is terminated. Hence, it is required that the data errors accumulated are limited to the correcting capability of the ECC. The initial values in Step 212 (and the threshold value in Step 206) are set according to accumulations of the data errors. For example, as a flash memory has a better capability of maintaining charges in floating gates, charge lost of each data reading is less, so that a difference between the threshold value and the initial value can be larger, which means that the flash memory allows more number of times of reading data before the charge is drained. When the level of data loss of the flash memory is serious, the difference between the threshold value and the initial value should be reduced, so that data refreshing is triggered more frequently in Step 210 to overcome reading disturbance.

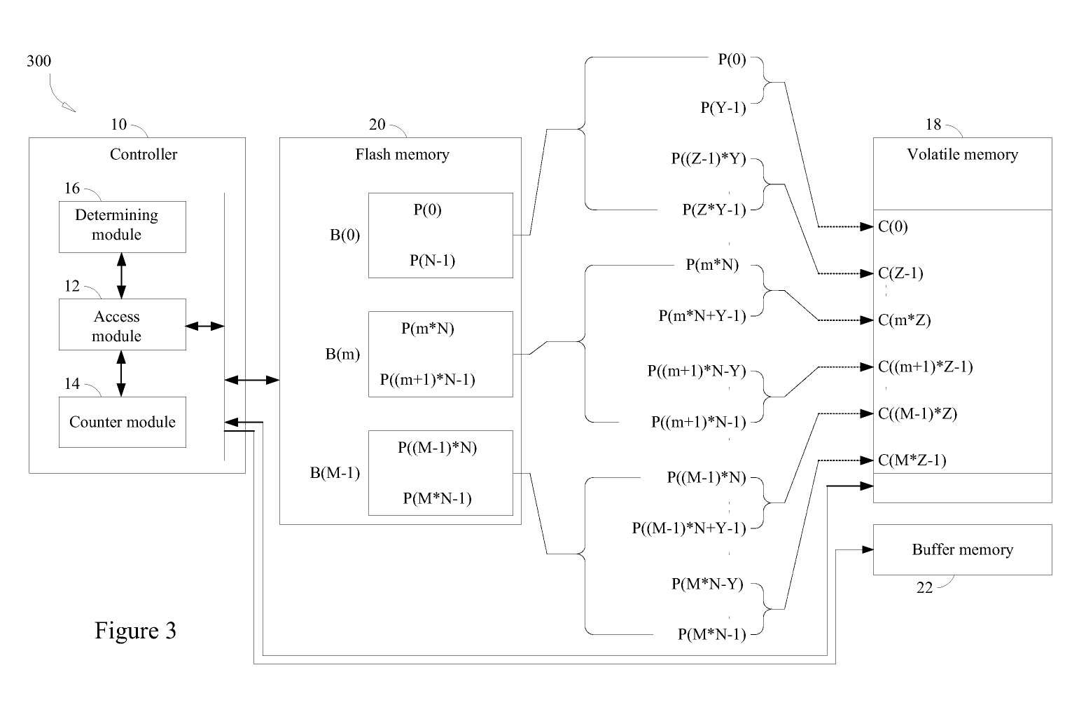

The techniques in FIG. 1 and FIG. 2 can be applied to an electronic system 300 in FIG. 3. The electronic system 300 comprises a controller 10, a flash memory 20, a volatile memory 18, and a buffer memory 22. The flash memory is an NAND multi-level cell flash memory or other types of flash memories that provide non-volatile memory space to the electronic system 200. The flash memory 20 comprises M blocks B(0) to B(M−1), and each block B(m) (m is from 0 to (M−1)) comprises N data units (e.g., pages), P(m*N) to P((m+1)*(N−1)). For example, the block B(0) comprises N data units P(0) to P(N−1), and the block B(M−1) comprises N data units P((M−1)*N) to P(M*N−1).

The volatile memory 18 is a DRAM or an SRAM for providing volatile memory space to the electronic system 300. For example, the volatile memory 18 provides memory space temporarily for operation of the controller 10. The buffer memory 22 is also a volatile memory. For example, the buffer memory 22 and the volatile memory 18 may be realized in the same volatile memory apparatus, or the buffer 22 may be separately realized by a register (e.g., a first-in first-out (FIFO) register). Other configurations of volatile memory 18 and buffer memory 22 may also be utilized with the invention. The controller 10 reads the flash memory 20, and the buffer memory 22 provides buffer memory space for the flash memory. For example, when the controller 10 reads the flash memory 20, data read from the flash memory 20 are temporarily stored in the buffer memory 22. When the controller 10 writes data into the flash memory 20, the data are temporarily stored in the buffer memory 22.

According to the present invention, the controller 10 comprises an access module 12, a counter module 14, and a determining module 16. The access module 12 is coupled to the flash memory 20 via an appropriate interface circuit (not shown in FIG. 3) to access the flash memory 20, and is also coupled to the volatile memory 18 and the buffer memory 22 for access and information transfer. The counter module 14 counts number of times each of the data units P(0) to P(M*N−1) being read, and the determining module 16 determines whether to refresh data of each data unit according to the read times of each data unit.

Referring to FIG. 3, the counter module 14 accesses the volatile memory 18 via the access module 12 to configure a plurality of counters C(0) to C(M*Z−1), each counter corresponding to a set of data units. The counter module 14 is coupled to the counters, each counter recording a count value for each set of data units, and each data unit corresponds to one (and only one) of the counters. When the access module 12 reads the data units, the counter module 14 adds a predetermined increment to count values of the counters corresponding to the data units so as to count the times each data unit are read according to the count values. In this embodiment, every Y number of data units (where Y is larger than or equal to 1) correspond to one counter, e.g., the data units P(0) to P(Y−1) correspond to a counter C(0), the data units P(m*N) to P(m*N+Y−1) correspond to the counter C(m*Z), and the like.

As an example, when X bytes of the volatile memory 18 are for configuring the counters, each of the counters occupies 2 bytes for recording count values from 0 to 65535, so that the X bytes can accommodate X/2 counters. Since M blocks of the flash memory 20 respectively correspond to Z counters, there are a total of M*Z counters, so that M*Z is equal to Z/2, i.e., Z=X/(2*M). That is, according to the overall number X of bytes of the volatile for configuring the counters and the overall number M of blocks of the flash memory 20, the number Z of the counters corresponding to each block is calculated. Accordingly, an overall number Y of the data units (e.g., pages) corresponding to each counter is calculated as Y=N/2, where N is an overall number of the data units of one block.

Since every Y data units P(k*Y) to P((k+1)*Y−1) correspond to one counter C(k) (where k=1 to (M*Z−1)), memory capacity of the buffer memory 22 is associated with the Y data units corresponding to one counter. When the access module 12 reads one of the data units P(k*Y) to P((k+1)*Y−1), other Y−1 data units corresponding to the counter C(k) are simultaneously read into the buffer memory 22, and an increment is added to a count value of the counter C(k). Accordingly, the read number of times of each of the Y data units corresponding to the same counter is recorded as the same, and the data of the buffer memory 22 are cached.

As described in the flow 200 in FIG. 2, when a count value of a counter C(k) is greater than a threshold value, the determining module 16 refreshes the data units P(k*Y) to P((k+1)*Y−1) corresponding to the counter C(k) via the access module 12. For example, the determining module 16 allocates from the data units P(0) to P(M*N−1) another Y number of unused spare data units P(k′*Y) to P((k′+1)*Y−1) as replacement data units of the to-be-refreshed data units P(k*Y) to P((k+1)*Y−1). The access module 12 correspondingly replicates and writes data of the data units P(k*Y) to P((k+1)*Y−1) into the replacement data units P(k′*Y) to P((k′+1)*Y−1), and the counter module 14 redefines a count value of a counter C(k′) corresponding to the data units P(k′*Y) to P((k′+1)*Y−1) as an initial value. In practice, the access module 12 refreshes data of a block B(i) comprising the data units P(k*Y) to P((k+1)*Y−1), i.e., the determining module 16 allocates from blocks B(0) to B(M−1) an unused spare block B(j) for replacing the to-be-refreshed bock B(i). The access module 12 respectively replicates data in all N data units of the block B(i) into N data units of the replacement block B(j), and the counter module 14 reconfigures Z counters corresponding to the block B(j) to be the initial value.

When the flash memory 20 ceases working, the access module 12 writes count values of counters C(0) to C(M*Z−1) back to the flash memory 20. When the controller 10 accesses the flash memory 20 again, the access module 12 loads the count values saved in the flash memory 20 into the counters C(0) to C(M*Z−1) configured in the volatile memory 18 so as to continuously monitor reading of the flash memory. For example, when the electronic system 300 is turned off, the count values in the volatile memory 18 are written into the flash memory 20 to save the count values in the non-volatile memory. When the electronic system 300 is again turned on, data reading times of the flash memory 20 are accumulated using the count values as the initial value. Alternatively, the flash memory is a removable device. When the flash memory 20 is removed from the electronic system 300, the count values are written into the flash memory 20 in advance. When the flash memory 20 is again plugged into the electronic system 300, the count values saved in the flash memory 20 are loaded into corresponding counters of the volatile memory 18.

In the controller 10, functions of the counter module 14 and the determining module 16 are realized by software or firmware programs executions via a microprocessor (not shown in FIG. 3). The buffer memory 22 and/or the volatile memory 18 may be integrated with the controller 10 to a control chip. Alternatively, the controller 10, the buffer memory 22 and/or the volatile memory 18 may be realized in different chips.

In conclusion, according to the present invention, data integrity and accuracy are maintained by appropriately refreshing data of a flash memory according to usage status (e.g., read instances) of the flash memory. In certain video electronic systems (e.g., digital frames), since video data of flash memories are read in high speed due to high frame update frequency, the electronic systems are extremely sensitive to disturbance caused by reading of the flash memories. According to the present invention, an electronic system can overcome read interferences of the flash memory to effectively avoid data errors and data loss caused by accumulation of read instances.

While the invention has been described in terms of what is presently considered to be the most practical and preferred embodiments, it is to be understood that the invention needs not to be limited to the above embodiments. On the contrary, it is intended to cover various modifications and similar arrangements included within the spirit and scope of the appended claims which are to be accorded with the broadest interpretation so as to encompass all such modifications and similar structures.

What is claimed is:

1. A method applied to a flash memory comprising a plurality of data units, the method comprising:
counting a number of times that the data units are read, to generate a plurality of count values; and
determining whether to refresh data in the data units according to the count values.

2. The method as claimed in claim 1, further comprising:
allocating a plurality of counters for recording the count values, with each data unit corresponding to one of the counters;
adding a predetermined increment to the count value of the counter corresponding to a data unit when the data unit is read; and
counting the number of times that the data units are read according to the plurality of the count values of the counters.

3. The method as claimed in claim 2, wherein the plurality of data units are assigned to one same counter when allocating the counters.

4. The method as claimed in claim 3, further comprising:
when one of the data units is read, reading all other data units assigned to the same counter.

5. The method as claimed in claim 2, further comprising:
refreshing the data units assigned to the counter when the count value is determined to be greater than a threshold value.

6. The method as claimed in claim 5, wherein the step of refreshing the data units further comprises: when the data units assigned to the same counter are to be refreshed, allocating an unused data unit from the flash memory as a replacement data unit, into which data of the to-be-refreshed data unit are written.

7. The method as claimed in claim 5, further comprising:
resetting the count value of the counter assigned to the data units to be an initial value when the data units corresponding to the counter are refreshed.

8. The method as claimed in claim 2, wherein the flash memory is configured as a plurality of blocks each comprising a plurality of the data units, the method comprises:
allocating the counters for each block, with each data unit of each block corresponding to one of the counters.

9. The method as claimed in claim 8, further comprising:
refreshing the block when the count value of one of the counters corresponding to the block is greater than a threshold value.

10. The method as claimed in claim 9, wherein the step of refreshing the block further comprises: before the block is to be refreshed, allocating an unused block from the flash memory as a replacement block, into which data of the to-be-refreshed block are written.

11. The method as claimed in claim 10, further comprising:
resetting the count values of counters corresponding to the replacement block to be an initial value when the block is refreshed.

12. The method as claimed in claim 2, wherein the counters is allocated in a volatile memory, and the method comprises:
writing the count values of the counters from the volatile memory into the flash memory when the flash memory ceases working.

13. The method as claimed in claim 12, further comprising:
loading the count values in the flash memory into the counters configured in the volatile memory while initializing the flash memory.

14. A controller applied to a flash memory, the flash memory comprising a plurality of data units for storing data, the controller comprising:
an access module, coupled to the flash memory, for accessing the flash memory;
a counter module, coupled to the access module, for counting a number of times that the data units are read, to generate a plurality of count values; and
a determining module, coupled to the access module, for selectively refreshing data of the data units according to the count values.

15. The controller as claimed in claim 14, wherein the counter module is coupled to a plurality of counters for recording the count values, each data unit is assigned one of the counters, and each count value represents the number of times that each data unit is read.

16. The controller as claimed in claim 15, wherein the counter module corresponds to the plurality of data units to one of the counters, and the access module is coupled to a buffer memory of which memory capacity is associated with the data units assigned to the same counter, and when the access module reads one of the data units, the other data units of the same counter are read simultaneously with the initial data unit so that all the data units assigned to the same counter are read into the buffer memory.

17. The controller as claimed in claim 15, wherein when one count value of the counters is greater than a threshold value, the determining module enables the access module to refresh data units corresponding to the counter.

18. The controller as claimed in claim 17, wherein when the access module refreshes the data units corresponding to the counter, the determining module allocates an unused data unit from the flash memory for each to-be-refreshed data unit as a replacement data unit, and the access module writes data of each data units corresponding to the counter into each replacement data unit.

19. The controller as claimed in claim 15, wherein the flash memory is configured as a plurality of blocks each comprising a plurality of data units, and each block is assigned to a plurality of counters in a way that every data unit of each block is assigned to one of the counters.

20. The controller as claimed in claim 19, wherein when one count value of the counters corresponding to each block is greater than a threshold value, the access module refreshes the block, the determining module allocates from the flash memory an unused block as a replacement block for the to-be-refreshed block, and the access module writes data of data units of the to-be-refreshed block into data units of the replacement block.
